(19) United States
(12) Patent Application Publication
(10) Pub. No.: US 2016/0176029 A1
(43) Pub. Date: Jun. 23, 2016

(54) DIGITAL CONTROL MODULE FOR TORQUE WRENCH

(71) Applicant: Wei-Ning Hsieh, Taichung City (TW)

(72) Inventor: Wei-Ning Hsieh, Taichung City (TW)

(21) Appl. No.: 14/578,487

(22) Filed: Dec. 22, 2014

(51) Int. Cl. B25B 23/142

(52) U.S. Cl. CPC B25B 23/1422

(57) ABSTRACT

A digital control module for a torque wrench contains an operating handle and a fitting assembly. The operating handle includes a ratchet working head having a connecting post for fitting with a socket. The fitting assembly includes a digital area and a gripping extension, and the digital area has a digital processing unit, a display member, and a starting button. The fitting assembly also includes a groove for inserting the operating handle, and the working handle also includes at least one strain gauge attached thereon to correspond to the fitting assembly which is fitted with the working head. The at least one strain gauge is electrically connected with the digital processing unit, and the gripping extension has at least one setting button fixed thereon and electrically connecting with the digital processing unit. The gripping extension also has a protective cover disposed thereon to cover the at least one setting button.

### FIELD OF THE INVENTION

The present invention relates to a digital control module for a torque wrench in which at least one setting button is disposed on a gripping extension of the torque wrench to decrease a configuration space and a length of the torque wrench.

### BACKGROUND OF THE INVENTION

A conventional torque wrench is applied to screw/unscrew a bolt with/from a nut at a set torque value. Preferably, the convention torque wrench contains a digital control module to display a torque value.

For example, a torque wrench with vibration and warming function is disclosed in TW Patent No. M400911 and contains a hollow stem and a ratchet operating assembly fixed on a front end of the hollow stem to fit with a socket. The torque wrench also contains a gripping extension and a setting assembly which are disposed on a rear end of the hollow stem, and the setting assembly has a display member and plural function buttons for setting a torque value or modifying a display mode of the display member; a hollow metal tube inserted into the hollow stem; and a vibrating assembly mounted in the hollow metal tube and corresponding to the gripping extension of the hollow stem; such that when an operating force of a user reaches the set torque value, the display member sends a signal toward a motor fixed on the gripping extension, and the motor vibrates to remind the user to stop operation.

However, the plural function buttons are arranged between the gripping extension and the display member or between the display member and the ratchet operating assembly, thus increasing a length of the torque wrench and production cost.

The present invention has arisen to mitigate and/or obviate the afore-described disadvantages.

### SUMMARY OF THE INVENTION

The primary object of the present invention is to provide a digital control module for a torque wrench in which at least one setting button is disposed on an gripping extension of the torque wrench to decrease a configuration space and a length of the torque wrench.

Another object of the present invention is to provide a digital control module for a torque wrench which contains a protective cover to prevent the at least one setting button from being touched as a user grips the gripping extension.

To obtain the above objects, a digital control module for a torque wrench provided by the present invention contains: an operating handle and a fitting assembly.

The operating handle includes a ratchet working head disposed on one end thereof, and the working head has a connecting post mounted therein to fit with a socket.

The fitting assembly includes a digital area and a gripping extension, and the digital area has a digital processing unit formed therein, a display member and a starting button which are arranged on the digital area.

The fitting assembly also includes a groove defined in the digital area for inserting the operating handle, and the working handle also includes at least one strain gauge attached on a predetermined zone thereof to correspond to the fitting assembly which is fitted with the working head, the at least one strain gauge is electrically connected with the digital processing unit, and the gripping extension has at least one setting button fixed thereon and electrically connecting with the digital processing unit, the gripping extension also has a protective cover disposed thereon to cover the at least one setting button.

Furthermore, the gripping extension further has a stepped slot formed thereon to accommodate the at least one setting button, and the stepped slot has a first recessed portion and a second recessed portion, wherein a depth of the first recessed portion is more than that of the second recessed portion, and an area of the first recessed portion is less than that of the second recessed portion, the gripping extension further has a press piece mounted on the first recessed portion to cover the at least one setting button, and the protective cover is disposed on the second recessed portion of the gripping extension and flushes with the gripping extension.

Thereby, the at least one setting button is configured on the gripping extension to decrease a size of the digital area, such that a length of the torque wrench is reduced, and the protective cover prevents the at least one setting button being touched by a user after setting the torque value.

### BRIEF DESCRIPTION OF THE DRAWINGS

FIG. 1 is a perspective view showing the exploded components of a digital control module for a torque wrench according to a preferred embodiment of the present invention.

FIG. 2 is a perspective view showing the assembly of the digital control module for the torque wrench according to the preferred embodiment of the present invention.

FIG. 3 is a perspective view showing the operation of the digital control module for the torque wrench according to the preferred embodiment of the present invention.

FIG. 4 is a plan view showing the operation of the digital control module for the torque wrench according to the preferred embodiment of the present invention.

### DETAILED DESCRIPTION OF THE PREFERRED EMBODIMENTS

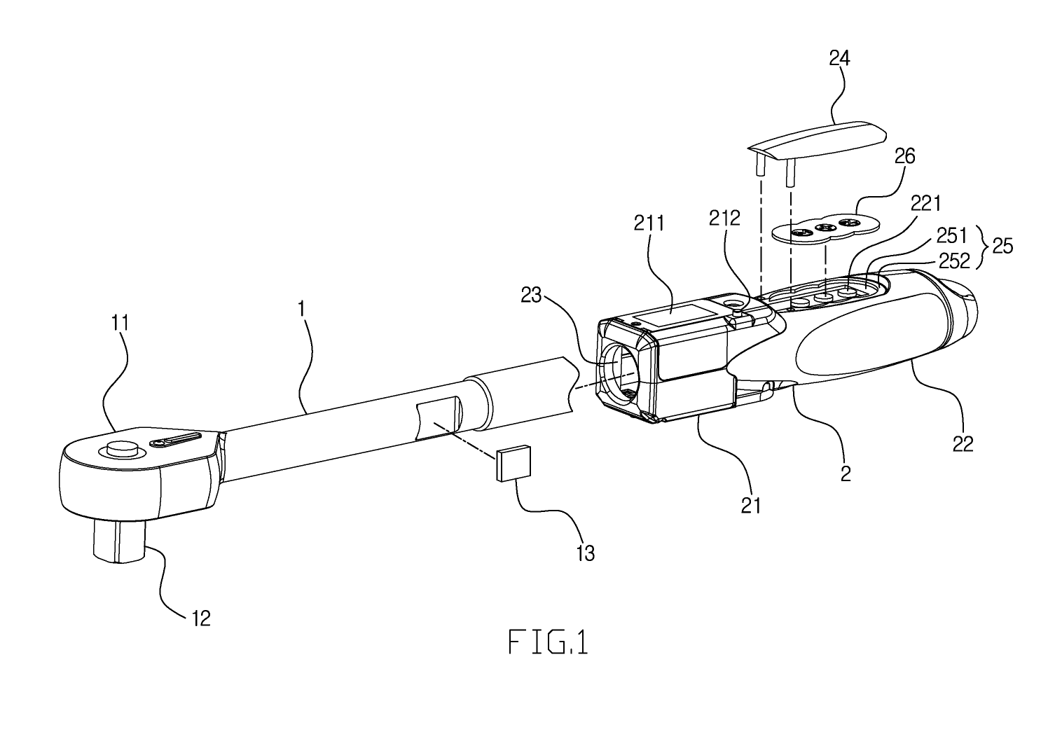

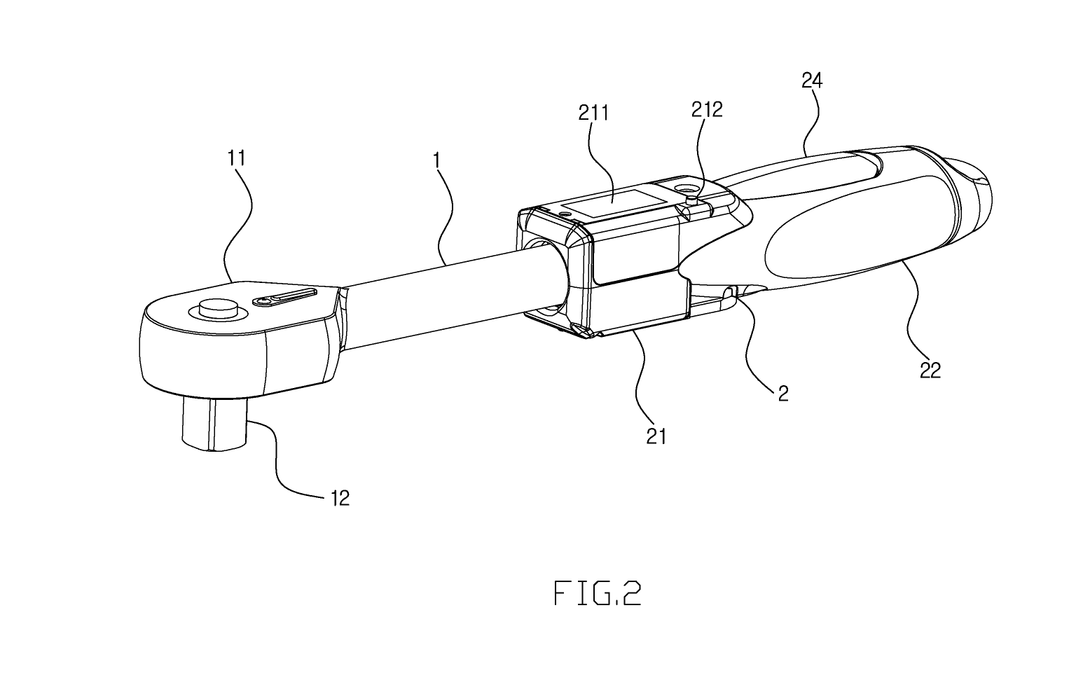

With reference to FIGS. 1-4, a digital control module for a torque wrench according to a preferred embodiment of the present invention is employed to set a torque value for operating a torque wrench and comprises an operating handle 1 and a fitting assembly 2.

The operating handle 1 includes a ratchet working head 11 disposed on one end thereof, and the working head 11 has a connecting post 12 mounted therein to fit with a socket. The fitting assembly 2 includes a digital area 21 and a gripping extension 22, and the digital area 21 has a digital processing unit (not shown) formed therein, a display member 211 and a starting button 212 which are arranged on the digital area 21. The fitting assembly 2 also includes a groove 23 defined in the digital area 21 for inserting the operating handle 1, and the working handle 1 also includes at least one strain gauge 13 attached on a predetermined zone thereof to correspond to the fitting assembly 2 which is fitted with the working head 1, the at least one strain gauge 13 is electrically connected with the digital processing unit, and the gripping extension 22 has at least one setting button 221 fixed thereon and electrically connecting with the digital processing unit. The gripping extension 22 also has a protective cover 24 disposed thereon to cover the at least one setting button 221.

Thereby, the at least one setting button 221 is configured on the gripping extension 22 to decrease a size of the digital area 21, such that a length of the torque wrench is reduced, and the protective cover 24 prevents the at least one setting button 221 being touched by a user after setting the torque value.

The gripping extension 22 further has a stepped slot 25 formed thereon to accommodate the at least one setting button 221, and the stepped slot 25 has a first recessed portion 251 and a second recessed portion 252, wherein a depth of the first recessed portion 251 is more than that of the second recessed portion 252, and an area of the first recessed portion 251 is less than that of the second recessed portion 252. The gripping extension 22 further has a press piece 26 mounted on the first recessed portion 251 to cover the at least one setting button 221, wherein the press piece 26 is made of flexible plastic material, and the protective cover 24 is disposed on the second recessed portion 252 of the gripping extension 22 and flushes with the gripping extension 22.

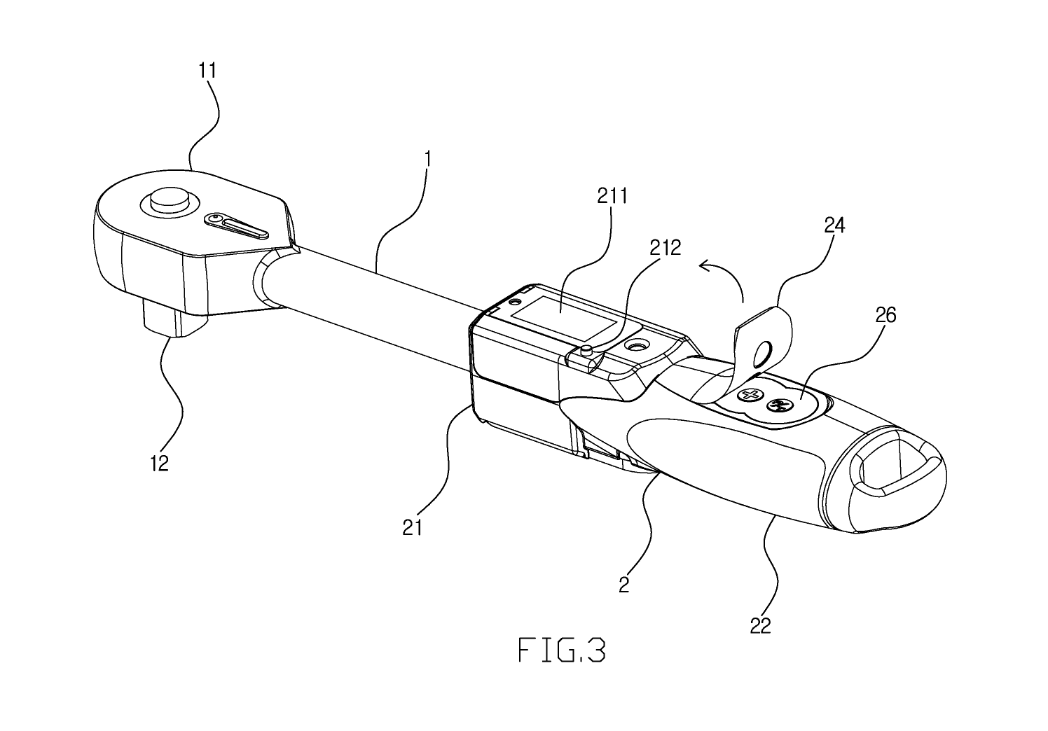

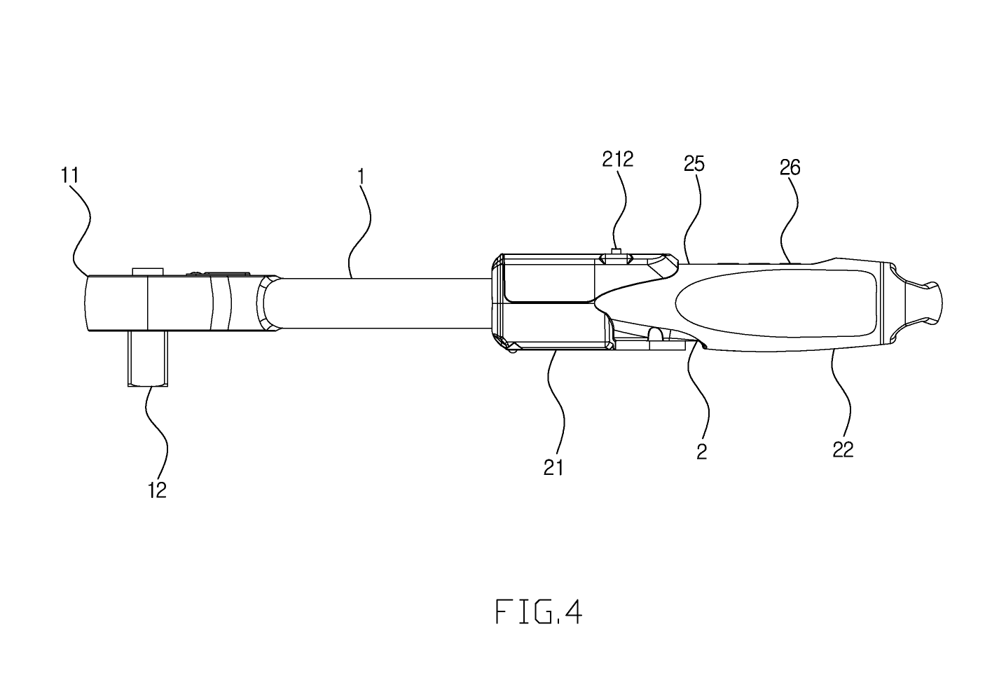

Preferably, the protective cover 24 is made of rubber to be flexible, such that the protective cover 24 is pulled upwardly to set the at least one setting button 221 (as shown in FIG. 3). In addition, after removing the protective cover 24 and gripping the gripping extension 22, the at least one setting button 221 is not touched by the user by using the stepped slot 25 (as illustrated in FIG. 4).

Accordingly, the at least one setting button is disposed on the gripping extension of the torque wrench to decrease a configuration space and the length of the torque wrench. Furthermore, the protective cover 24 prevents the at least one setting button 221 from being touched as the user grips the gripping extension 22.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A digital control module for a torque wrench comprising an operating handle and a fitting assembly;
the operating handle including a ratchet working head disposed on one end thereof, and the working head having a connecting post mounted therein to fit with a socket;
the fitting assembly including a digital area and a gripping extension, and the digital area having a digital processing unit formed therein, a display member and a starting button which are arranged on the digital area;
the fitting assembly also including a groove defined in the digital area for inserting the operating handle, and the working handle also including at least one strain gauge attached on a predetermined zone thereof to correspond to the fitting assembly which is fitted with the working head, the at least one strain gauge being electrically connected with the digital processing unit, and the gripping extension having at least one setting button fixed thereon and electrically connecting with the digital processing unit, the gripping extension also having a protective cover disposed thereon to cover the at least one setting button.

2. The digital control module for the torque wrench as claimed in claim 1, wherein the gripping extension further has a stepped slot formed thereon to accommodate the at least one setting button, and the stepped slot has a first recessed portion and a second recessed portion, wherein a depth of the first recessed portion is more than that of the second recessed portion, and an area of the first recessed portion is less than that of the second recessed portion, the gripping extension further has a press piece mounted on the first recessed portion to cover the at least one setting button, and the protective cover is disposed on the second recessed portion of the gripping extension and flushes with the gripping extension.
